(19) United States
(12) Patent Application Publication
(10) Pub. No.: US 2022/0371040 A1
(43) Pub. Date: Nov. 24, 2022

(54) CENTER BRACKET FOR ADJUSTING SPRINKLER BODY

(71) Applicant: Youngsoon LIM, Hwasung-si (KR)

(72) Inventor: Youngsoon LIM, Hwasung-si (KR)

(21) Appl. No.: 17/368,858

(22) Filed: Jul. 7, 2021

(30) Foreign Application Priority Data
May 14, 2021 (KR) 10-2021-0062658

(51) Int. Cl. B05B 15/62; B05B 15/68

(52) U.S. Cl. CPC B05B 15/62; B05B 15/68

(57) ABSTRACT

The present disclosure provides a center bracket for adjusting a sprinkler body that is formed so as to adjust the degree of tightening of the center bracket fixing the sprinkler body, which is convenient for an operator and can reduce the working time when fine adjustment is necessary during installation of firefighting facilities or during work.

### CROSS-REFERENCE TO RELATED APPLICATIONS

This application claims priority to and the benefit of Korean Patent Application No. 2021-0062658, filed on 14 May 2021, the disclosure of which is incorporated herein by reference in its entirety.

### TECHNICAL FIELD

The present disclosure relates to a center bracket for adjusting a sprinkler body, and more particularly, when fine adjustment is required in a state in which a firefighting facility is installed or generated during installation, to a center bracket for adjusting the sprinkler body, which is formed so as to adjust the degree of tightening of a sprinkler contact piece of the center bracket fixing the sprinkler body so that an operator may conveniently perform it and reduce a working time.

### BACKGROUND

A fire sprinkler has a structure that is fixed and supported on a support frame by a center bracket while maintaining a constant distance by being connected to a branch pipe that branches a fire extinguishing liquid into a plurality of supply pipes. There are several center brackets for supporting the sprinkler. Since one of them has a structure in which the center bracket is separated, a method of fixing and supporting the sprinkler by tightening force of a bolt by coupling separated elements to support the sprinkler is applied.

Such a center bracket has a problem in that it is not only cumbersome to work, but also an operation of loosening and tightening a bolt is difficult because a rotation operation and tightening force of the bolt are separately required for inserting the sprinkler and coupling elements after the center bracket is first separated for supporting the sprinkler.

An integrated center bracket developed by the present inventor is disclosed as Korean Patent No. 10-1422086.

In addition, the center bracket of the fire sprinkler developed by the present inventors has been published as Korean Utility Model Registration No. 20-0440808, and published as Korean Patent Publication No. 2011-97660. A conventional center bracket is fitted and coupled to a support frame, and a center bracket groove is formed on upper and lower portions of a bent surface so that a sprinkler may be clamped, respectively. In the conventional center bracket, a center bracket door is rotationally coupled to one side edge of the center bracket by a hinge pin, and a coupling groove is formed so that a center bracket space of a sprinkler body is provided while being combined with the center bracket groove of the center bracket.

The conventional center bracket has a problem that the center bracket and the center bracket door may not be coupled quickly and easily because while the center bracket door is rotated around a rotational coupling point of the hinge pin, the center bracket door does not slide to an opposite side of the rotational coupling point. The conventional center bracket has a problem that a fastening groove of the center bracket door should be formed with a structure in which the fastening groove is open to one side because while the center bracket door is rotated around the rotational coupling point of the hinge pin, the center bracket door does not slide to the opposite side of the rotational coupling point. Since the conventional center bracket has a structure in which the fastening groove of the center bracket door is opened to one side, there is a problem that the coupling between the center bracket and the center bracket door is disassembled or broken when a strong torque is applied.

The conventional center bracket has a problem that a fixed cam protrusion contact part is loosened in the opposite direction.

In order to solve the above problems, as in Korean Patent No. 10-2094897 (Mar. 24, 2020), a sprinkler center bracket is provided with a cam lever loosening prevention locker that can prevent loosening, but there was a problem that the whole should be released, which is troublesome and a work time becomes long at the time of replacement or adjustment in construction.

In addition, when an operator needs a convenient fine adjustment when setting a correct height during construction, the operator may not easily modify the center bracket, and thus, there was a problem that the center bracket falls out due to the load when setting by loosening the entire clamp of the center bracket, setting it again, and then fixing it.

### SUMMARY

### Technical Problem

An object of the present disclosure devised to solve problems in the related art is directed to providing a center bracket for adjusting a sprinkler body so that the sprinkler body may be conveniently moved while being fastened and that an operator can work quickly and conveniently.

Another object of the present disclosure is directed to providing a sprinkler center bracket for fine adjustment that is convenient to manufacture, can reduce production costs, and is convenient for fine adjustment after work.

### Technical Solution

A configuration of the present disclosure for solving the above-mentioned problems includes,

in a center bracket for fixing a sprinkler body,

a hinge pin fixed to a pinhole of the center bracket and formed so as to be fixed by pressing a sprinkler contact piece which is rotated with the hinge pin as the central axis of rotation, wherein the sprinkler contact piece is formed of left and right legs and an upper plate so that the sprinkler body is closely fixed, a contact piece recess formed toward the left and right legs to form the sprinkler body in close contact, a tapered upper plate in which an upper surface of the sprinkler contact piece has an inclined surface, wherein the tapered upper plate is formed to be pressed by pressing from a side surface with an adjustment lever, or a cut-out piece cut on a side surface of the left or right leg of the sprinkler contact piece formed to be bent inward to be inclined at about 45 degrees, and the adjustment lever formed perpendicular to the cut-out piece or the tapered upper plate.

A through-hole is formed on one side surface of a bent surface bent in a “⊏” shape of the center bracket, and the adjustment lever having a thread is formed in the through-hole so that the height of the sprinkler body is adjusted by rotating the adjustment lever to press and fix or release the sprinkler contact piece, and accordingly, workers may conveniently reduce installation and location adjustment time.

### Advantageous Effects

Since the center bracket for adjusting the sprinkler body of the present disclosure uses a rotating and pressing method that is convenient for the operator to install, it forms a center bracket that can be quickly mounted with little force, and if necessary, when the operator conveniently moves the sprinkler body, it is formed to be adjusted with the adjustment lever so that it can be finely adjusted, and there is a very useful effect of quickly and conveniently pressing the sprinkler contact piece.

### BRIEF DESCRIPTION OF THE DRAWINGS

FIG. 1 is a state diagram of mounting and use of a center bracket for adjusting a sprinkler body according to a preferred embodiment of the present disclosure.

FIG. 2 and FIG. 3 are an operating state diagram of a sprinkler contact piece and an adjustment lever of the center bracket of the present disclosure.

FIG. 4 is an exploded perspective view in which a locking device is mounted on the sprinkler contact piece according to the embodiment of the present disclosure.

FIG. 5 is an operation state diagram showing a spring mounted on the sprinkler contact piece of the center bracket for adjusting the sprinkler body of the present disclosure.

FIG. 6 is an operating state diagram in which the spring mounted on the sprinkler contact piece of the center bracket for adjusting the sprinkler body of the present disclosure are arranged so as to act in a clockwise.

FIG. 7 shows an example of the sprinkler contact piece according to another embodiment of the present disclosure.

FIG. 8 is a state diagram in which a roller is formed on an adjustment lever according to another embodiment of the present disclosure.

FIG. 9 is a perspective view of an operating state in which a cam protrusion contact part on which a cam lever is formed is further formed on the center bracket for adjusting the sprinkler body according to still another embodiment of the present disclosure.

FIG. 10 is an exploded perspective view of the cam protrusion contact part in which the cam lever is formed on the center bracket for adjusting the sprinkler body of the present disclosure.

FIG. 11 is an operating state diagram of the center bracket of the present disclosure.

FIG. 12 is an operating state diagram of the cam protrusion contact part and the adjustment lever of the present disclosure.

FIGS. 13 and 14 are operation state diagrams of an adjustment lever formed on an upper portion of the center bracket of the present disclosure and an adjustment lever installed on a lower portion.

FIG. 15 is a usage state diagram according to another embodiment of the present disclosure.

### DETAILED DESCRIPTION OF THE EMBODIMENTS

Advantages and features of the present disclosure, and methods of achieving the same will be clearly understood with reference to the accompanying drawings and the following detailed embodiments. However, the present disclosure is not limited to the embodiments to be disclosed, but may be implemented in various different forms. The embodiments are provided in order to fully explain the present disclosure and fully explain the scope of the present disclosure for those skilled in the art. The scope of the present disclosure is only defined by the appended claims.

The terms used in the embodiments of the present disclosure are for describing the embodiments and are not intended to limit the present disclosure. In this specification, the singular forms may also include the plural forms unless specifically stated in the phrase. As used herein, “comprises” and/or “comprising” does not exclude the presence or addition of one or more other elements in addition to the stated elements. Throughout the specification, the same reference numerals refer to the same elements, where “and/or” includes each of the mentioned elements and any combination of one or more. Although the terms “first”, “second”, etc. are used to describe various elements, of course, these elements are not limited by these terms. These terms are only used to distinguish one element from another. Accordingly, it goes without saying that the first element mentioned below may be the second element within the technological scope of the present disclosure.

Unless otherwise defined, all terms (including technical and scientific terms) used herein may be used with the meaning commonly understood by those of ordinary skill in the art to which the present disclosure belongs. In addition, the terms such as those defined in commonly used dictionaries are not to be interpreted ideally or excessively unless expressly otherwise defined.

Spatially relative terms “below”, “beneath”, “lower”, “above”, “upper”, and the like can be used to easily describe the relationship between an element and other elements as shown in the drawings. The spatially relative terms should be understood as terms including different directions of elements during use or operation in addition to the directions shown in the drawings. For example, when an element shown in the drawing is turned over, an element described as “below” or “beneath” of another element may be placed “above” of the other element. Accordingly, the exemplary term “below” may include both directions below and above. Elements may also be oriented in other orientations, and thus spatially relative terms may be interpreted according to orientation.

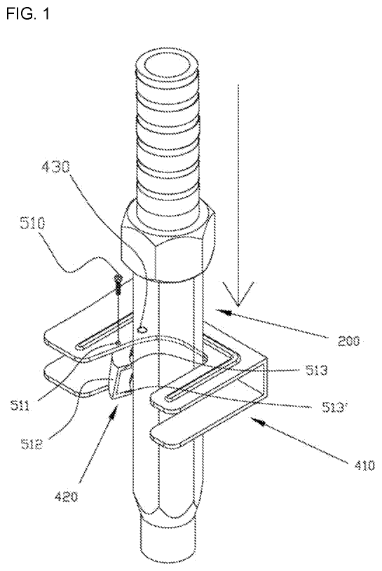

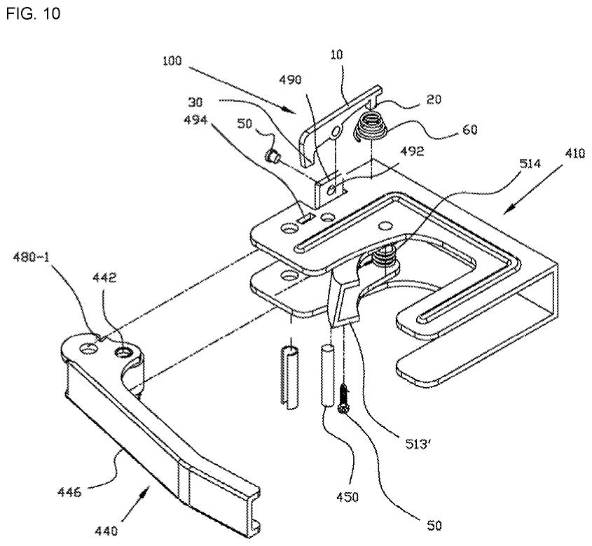

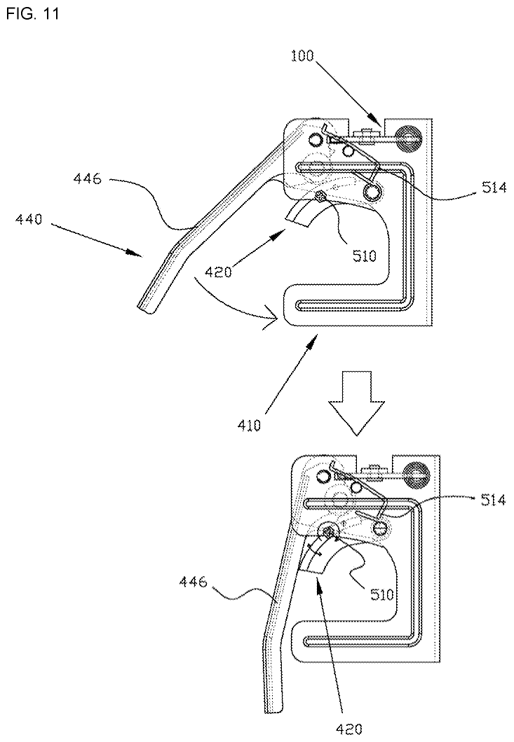

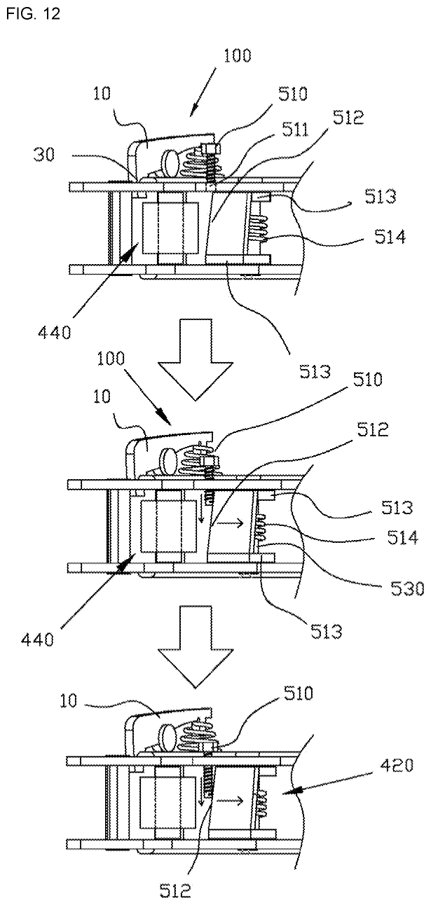

The present disclosure shown in FIGS. 1 to 15,

in a sprinkler center bracket composed of a center bracket 410 for fixing a sprinkler body 200 and a sprinkler contact piece 420 for fixing the sprinkler body 200 inside the center bracket,

A hinge pin 430 is fixed to a pinhole 414 of the center bracket 410 and formed so as to be fixed by pressing a sprinkler contact piece 420 which is rotated with the hinge pin 430 as the central axis of rotation, wherein the sprinkler contact piece 420 is formed of left and right legs 513 and 513″ and an upper plate 51) so that the sprinkler body 200 is closely fixed, and a contact piece recess 422 is formed toward the left and right legs to form the sprinkler body 200 in close contact.

A tapered upper plate 512 in which an upper surface of the sprinkler contact piece 420 has an inclined surface, wherein the tapered upper plate 512 is formed to be pressed by pressing vertically from a side surface with an adjustment lever.

A cut-out piece 524 cut on a side surface of the left or right leg of the sprinkler contact piece 420 is formed to be bent inward to be inclined at about 45 degrees, and an adjustment lever 510 formed perpendicular to the cut-out piece 524.

A through-hole 511 is formed on one side surface of a bent surface bent in a “⊏” shape of the center bracket, and the adjustment lever 510 having a thread is formed in the through-hole 511 so that the height of the sprinkler body 200 is adjusted by rotating the adjustment lever 510 to press and fix or release the sprinkler contact piece 420.

The center bracket 410 is used to fix an end bracket (not shown) formed on both sides of a support frame (not shown) for fixing to the ceiling and the sprinkler body 200 to the support frame. The center bracket 410 and the sprinkler contact piece 420 formed inside the center bracket 410 are formed to firmly fix the sprinkler body 200.

As shown in FIGS. 1 to 4,

In the sprinkler contact piece 420 formed inside the center bracket 410 of the present disclosure, the contact piece recess 422 and a mounting hole 419 are formed on one side thereof so that the sprinkler body 200 may be closely fixed, and the adjustment lever 510 is formed on an orbit rotated around the hinge pin 430 as the central axis of rotation by fixing the hinge pin 430 to the pinhole 414 of the center bracket 410 to press from a side surface so as to adjust a state in which the sprinkler contact piece 420 is pressed, the through-hole 511 is formed on each or one side surface of a bent surface 411 bent in a “c” shape of the center bracket, and the adjustment lever 510 having a thread is coupled to the through-hole 511.

A tapered upper plate 512 in which an upper surface of the sprinkler contact piece 420 has an inclined surface is formed to be pressed by pressing from a side surface thereof and formed to press the sprinkler contact piece 420 by tightening or loosening the adjustment lever 510.

As described above, it is possible to work in a loose state during correction by inserting the adjustment lever 510 into the tapered upper plate 512 and pushing so as to press the sprinkler contact piece 420, and thus, it may be adjusted by loosening a little without loosening the whole during correction.

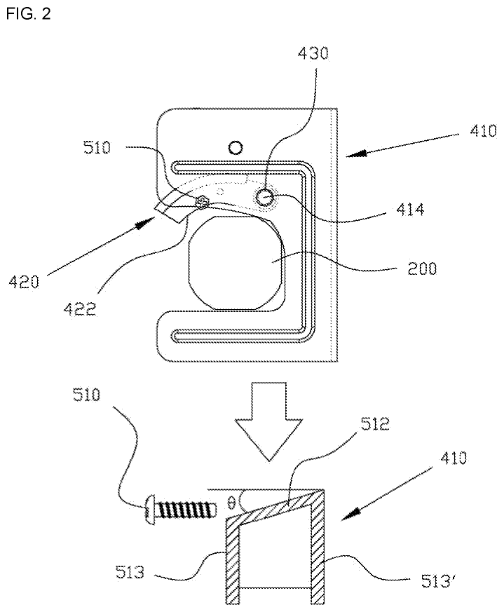

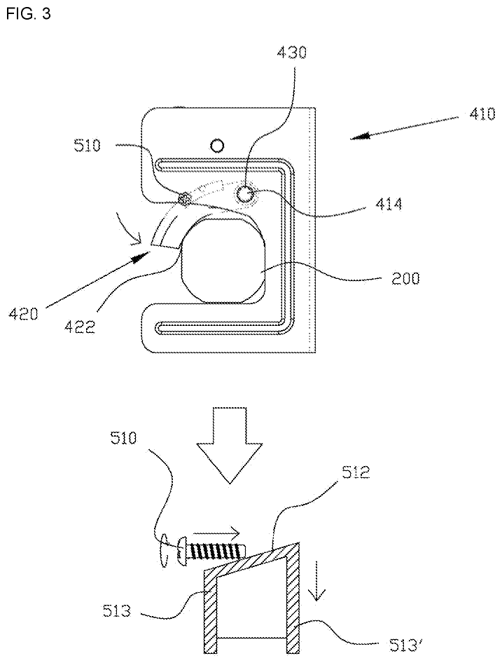

As in FIGS. 2 and 3, in an operation embodiment of the present disclosure, the sprinkler contact piece 420 is formed of the left and right legs 513 and 513′ and the tapered upper plate 512 so that the sprinkler body 200 inserted into the center bracket is closely fixed.

When the tapered upper plate 512 having the inclined surface on the upper surface is rotated so as to advance in the vertical direction towards the adjustment lever 510 from the side surface, the tapered upper plate 512 is pushed and pressed.

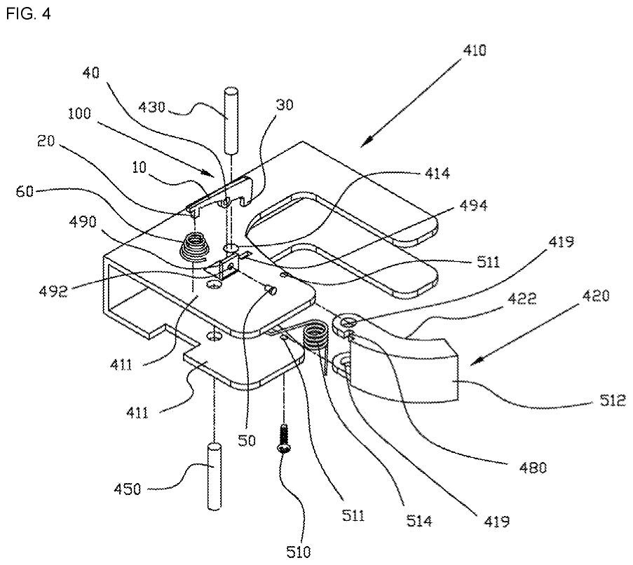

In another embodiment of the present disclosure shown in FIGS. 4 to 6, a locking device 100 capable of fixing the sprinkler contact piece 420 formed inside the center bracket 410 coupled to the sprinkler body 200 is formed.

The hinge pin 430 is fixed to the pinhole 414 of the center bracket 410 of the present disclosure to fix the sprinkler contact piece 420, and a coil spring 514 is formed on the hinge pin 430 by arranging in a clockwise or counterclockwise direction according to a direction of the coil spring 514.

The center bracket is formed so as to be fixed by pressing the sprinkler contact piece 420 which is rotated with the hinge pin 430 as the central axis of rotation, wherein the sprinkler contact piece 420 is formed of the left and right legs 513 and 513′ and the upper plate 512 so that the sprinkler body 200 is closely fixed, the contact piece recess 422 is formed toward the left and right legs, and the tapered upper plate 512 having the inclined surface on the upper surface of the sprinkler contact piece 420 is pressed by pressing the tapered upper plate 512 from the side surface.

In the present disclosure, a locker protrusion locking groove 480-1 is formed on a rotating shaft of the sprinkler contact piece 420 so as to be fixed by the locking device 100.

The locking device 100 of the present disclosure is formed to be fastened to the locker protrusion locking groove 480-1 of the sprinkler contact piece 420 on an upper surface of the center bracket 410.

In the locking device 100 of the present disclosure, a locker protrusion 30 is formed at one end portion of a locker body 10 that is rotated with a fixture 50 as the central axis of rotation, a spring protrusion 20 is formed at the other end portion, an elastic spring 60 is installed on the spring protrusion 20, and a fixing hole 40 is formed at a central portion of the locker body 10.

The fixing protrusion 490 is formed on one side of the center bracket 410, the fixing hole 492 is formed in the fixing protrusion 490, and the locker protrusion through-hole 494 is formed on one side of the fixing protrusion 490 to insert and fix the locker protrusion 30 of the locker body 10 thereinto.

The rocker body 10 is coupled by the fixture 50 being fitted into the fixing hole 492 of the fixing protrusion 490 formed on the bent surface of the center bracket 410 and passing through the fixing hole 40.

The locker protrusion locking groove 480-1 is arranged to be fitted as described above, and, and when rotating the sprinkler contact piece 520, the locker protrusion 30 of the locker body 10 is fitted into the locker protrusion locking groove 480-1 by the force of the elastic spring 60 so as to become a locked state.

In this case, the through-hole 511 is formed on one side surface of a bent surface bent in a “ [symbol] ” shape of the center bracket, and the adjustment lever 510 having a thread is formed in the through-hole 511 so that the height of the sprinkler body 200 is adjusted by pressing and fixing or releasing the sprinkler contact piece 420 with the adjustment lever 510.

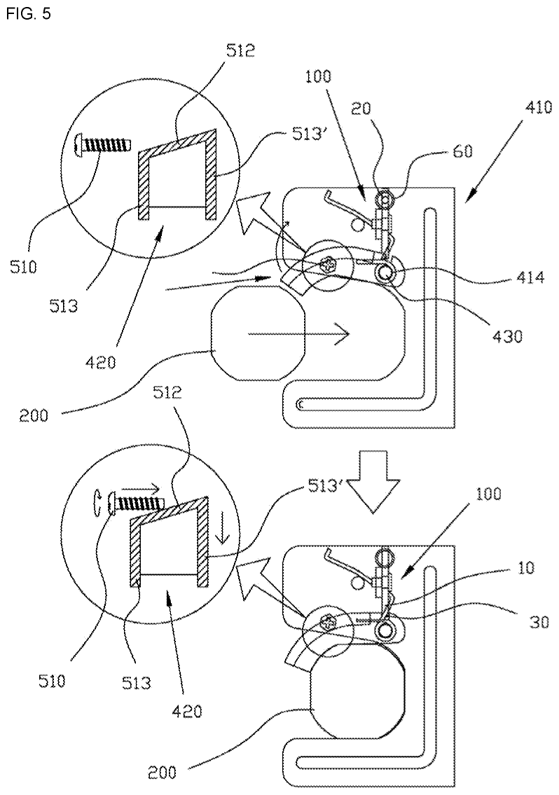

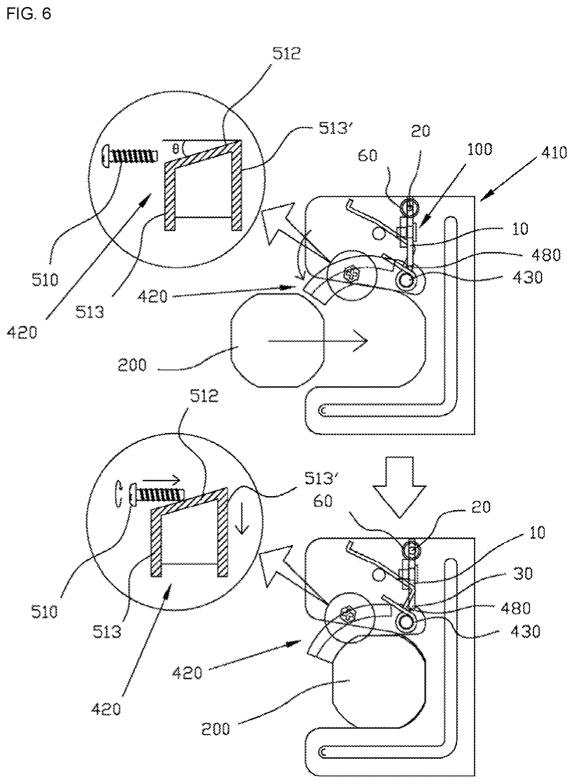

In the sprinkler contact piece 420 of the embodiment of the present disclosure shown in FIG. 5, the coil spring 514 is formed on the hinge pin 430 so that the rotation direction of the coil spring 514 is formed in a clockwise direction so as to form upward, or as shown in FIG. 6, it can be seen that it belongs to the right of the present disclosure that the rotation direction of the coil spring 514 is formed to arrange in a counterclockwise direction so as to enable selective production according to a user's convenience and an operator.

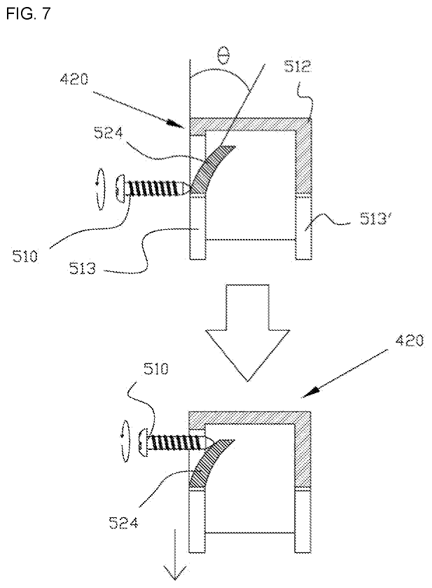

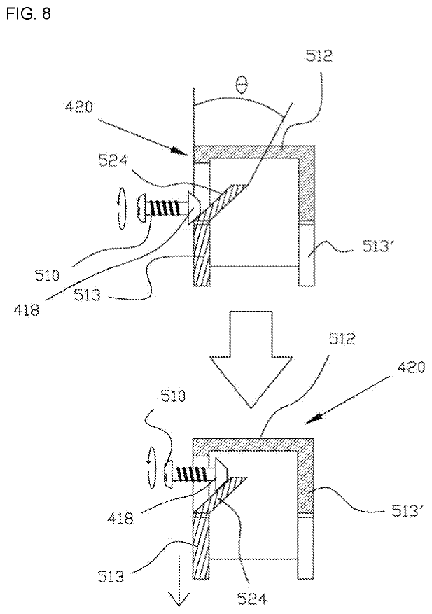

The sprinkler contact piece 420 of the present disclosure of FIGS. 7 and 8 is,

The cut-out piece 524 cut on a side surface of the left or right leg 513 or 513′ is formed by bending inward to be inclined at an inclination angle θ of about 45 degrees, and the adjustment lever 510 is formed perpendicular to the cut-out piece 524 to press.

As described above, the cut-out piece is formed on the side surface of the sprinkler contact piece 420 so as to adjust in a narrow space.

FIG. 8 is preferably achieved by forming a roller 418 or a ball-shaped structure to reduce a friction between the inclined cut-out piece 524 and the adjustment lever.

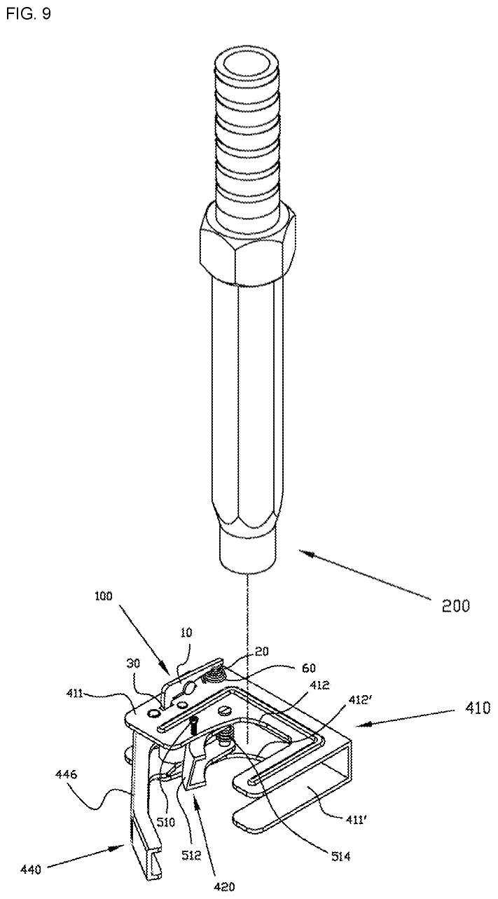

According to the present disclosure shown in FIGS. 9 to 14, the locking device 100 may be formed on the upper surface of the center bracket 410 so as to fix a cam protrusion contact part 440 formed so as to be in close contact by rotating a handle 446 of the cam protrusion contact part 440.

The present disclosure further includes the adjustment lever 510 that may be adjusted so as to be conveniently changed without completely loosening the handle 446 of the cam protrusion contact part 440 when changing a mounting position of the sprinkler body 200.

The through-hole 511 is formed on one side surface of a bent surface bent in a “ [symbol] ” shape of the center bracket, and the adjustment lever 510 having a thread is formed in the through-hole 511 so that the height of the sprinkler body 200 is adjusted by pressing and fixing or releasing the sprinkler contact piece 420 with the adjustment lever.

The fixing protrusion 490 is formed on one side of the center bracket 410, the fixing hole 492 is formed in the fixing protrusion 490, and the locker protrusion through-hole 494 is formed on one side of the fixing protrusion 490 to insert the locker protrusion 30 of the locker body 10 thereinto so that the locker protrusion 30 is fitted into a locker protrusion locking groove 480-1 at an end of a rotating part of the cam protrusion contact part 440.

At this time, when the locker body 10 of the locking device 100 is pressed, the locker protrusion is removed and the lock of the cam protrusion contact part 440 is released by the force of the elastic spring 60.

The cam protrusion contact part 440 is arranged to press the sprinkler contact piece 420 so that the sprinkler contact piece 420 may be fixed by pressing the sprinkler body, while after the sprinkler body 200 is moved upward or downward, the adjustment lever is rotated to strongly fix the sprinkler contact piece 420.

In addition, the roller 418 is formed on the adjustment lever so as to minimize friction by rotating in a friction portion of the sprinkler contact piece 420. As shown in the drawings, the adjustment lever 510 is formed with the through-hole 511 formed on an upper or lower surface of the bent surface 411 bent in the “ [symbol] ” shape of the center bracket so as to press the sprinkler contact piece 420.

The locking device 100 is composed of the cam protrusion contact part 440 that presses the sprinkler contact piece 420, and the cam protrusion contact part 440 is formed with a cam protrusion 442 having a shaft 460 and a roller 456 that are formed at one end of a cam lever 446 so that the cam protrusion 442 having an eccentric shaft is rotated to be fastened in a state in which the sprinkler body (including reducer) is fitted into a center bracket groove. and the locking device 100 is formed to press the sprinkler contact piece 420, is formed with the locker protrusion locking groove 480-1 formed on the cam protrusion 442 so that the cam lever 446 does not rotate, and is formed to be inserted into or removed from the locker protrusion locking groove 480-1.

While the through-hole 511 is formed, a seating groove 415 is formed to protrude upward so that the roller 418 is seated.

The adjustment lever 510 has a fitting protrusion 416 formed at an end thereof and couples to the roller 418 having a fitting groove 417 formed so as to be fitted and coupled to the fitting protrusion 416.

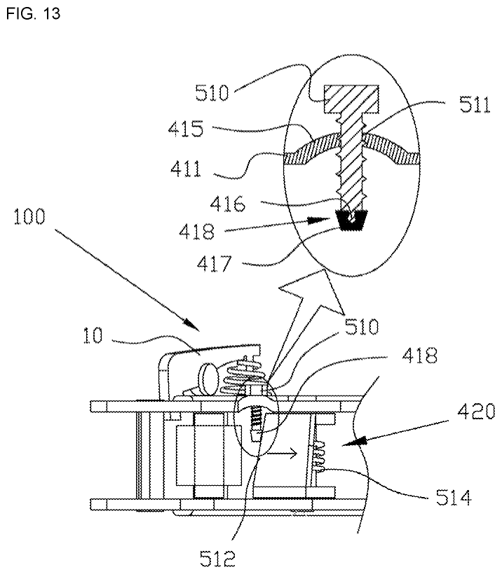

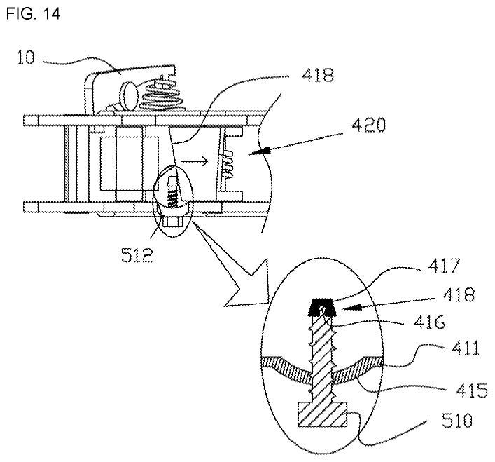

According to FIGS. 13 and 14, the sprinkler contact piece 420 of the present disclosure is formed with the adjustment lever 510 formed on an upper portion thereof so as to adjust the tapered upper plate 512 or the adjustment lever 510 formed on a lower portion thereof so as to adjust the tapered upper plate 512, and accordingly, it is possible to produce so as to be installed on the upper portion or the lower portion thereof by selecting according to the convenience of the operator or work method.

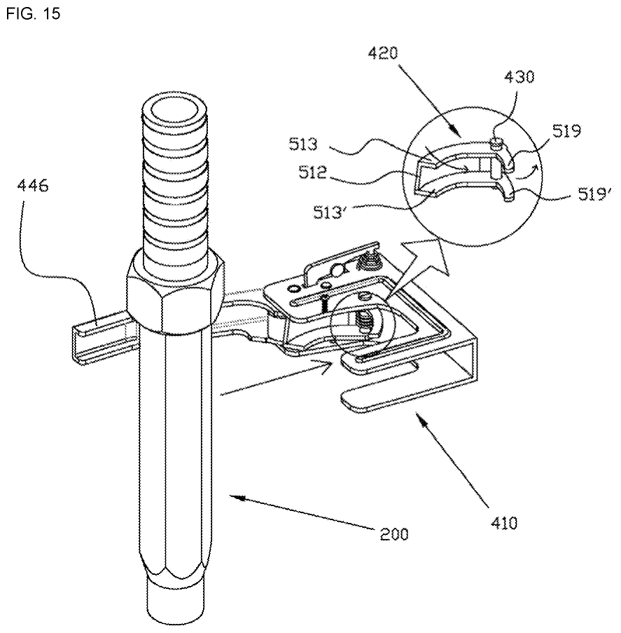

According to still another embodiment of the present disclosure shown in FIG. 15, the sprinkler contact piece 420 is formed with auxiliary rotary protrusions 519 and 519′ protruding from an end of a rotating part, so that the auxiliary rotary protrusions 519 and 519′ are pushed and the sprinkler contact piece 420 is rotated to wind and rotate the sprinkler body when the sprinkler body 200 is fitted.

As described above, the sprinkler body (including the reducer) is pushed and wound so that the operator may conveniently install it.

In addition, it can be seen that it belongs to the right of the present disclosure that the adjustment lever 510 of the present disclosure may be used as a lever having a protrusion so as to rotate by hand, or a screw, bolt, or the like so as to rotate by a tool.

DESCRIPTION OF REFERENCE NUMERALS

| | |
|---|---|
| 100: Locking device | 200: Sprinkler body |
| 418: Roller | 420: Sprinkler contact piece |
| 440: Cam protrusion contact part | 510: Adjustment lever |
| 511: Through-hole | 512: Upper plate |
| 514: Coil spring | |

What is claimed is:

1. In a sprinkler center bracket composed of a center bracket (410) for fixing a sprinkler body (200) and a sprinkler contact piece (420) for fixing the sprinkler body (200) inside the center bracket, a center bracket for adjusting a sprinkler body comprising:
a hinge pin (430) fixed to a pinhole (414) of the center bracket (410) and formed so as to be fixed by pressing a sprinkler contact piece (420) which is rotated with the hinge pin (430) as the central axis of rotation, wherein the sprinkler contact piece (420) is formed of left and right legs (513 and 513′) and an upper plate (512) so that the sprinkler body (200) is closely fixed,
a contact piece recess (422) formed toward the left and right legs to form the sprinkler body (200) in close contact,
a tapered upper plate (512) in which an upper surface of the sprinkler contact piece (420) has an inclined surface, wherein the tapered upper plate (512) is formed to be pressed by pressing from a side surface with an adjustment lever, or
a cut-out piece (524) cut on a side surface of the left or right leg of the sprinkler contact piece (420) formed to be bent inward to be inclined at about 45 degrees, and
an adjustment lever (510) formed perpendicular to the cut-out piece (524) or the tapered upper plate,
a through-hole (511) formed on one side surface of a bent surface bent in a “⊏” shape of the center bracket,
wherein the adjustment lever (510) having a thread is formed in the through-hole (511) so that the height of the sprinkler body (200) is adjusted by rotating the adjustment lever (510) to press and fix or release the sprinkler contact piece (420).

2. The center bracket for adjusting the sprinkler body of claim 1, wherein an upper surface of the bent surface (411) bent in the “i” shape of the center bracket or a lower surface of the bent surface is selected to form the through-hole (511) so as to mount the adjustment lever (510) for pressing the sprinkler contact piece (420).

3. The center bracket for adjusting the sprinkler body of claim 1, wherein a coil spring (514) is formed on the hinge pin (430), wherein the coil spring selects a coil spring wound in a right direction and a coil spring wound in a left direction so as to press the sprinkler contact piece (420) clockwise or counterclockwise.

4. The center bracket for adjusting the sprinkler body of claim 1, wherein a locking device (100) is formed on the center bracket (410), a locker protrusion (30) is mounted on an upper surface of the center bracket (410) and formed at one end portion of a locker body (10) that is rotated with a fixture (50) as the central axis of rotation, a spring protrusion (20) is formed at the other end portion, an elastic spring (60) is installed on the spring protrusion (20), a fixing hole (40) is formed at a central portion of the locker body (10), a fixing protrusion (490) is formed on one side of the center bracket (410), a fixing hole (492) is formed in the fixing protrusion (490), a locker protrusion through-hole (494) is formed on one side of the fixing protrusion (490) to insert the locker protrusion (30) of the locker body (10) thereinto, and the locker protrusion is inserted into a locker protrusion locking groove (480-1) formed on a rotation shaft of the sprinkler contact piece (420) to form a locked state so as not to rotate.

5. The center bracket for adjusting the sprinkler body of claim 1, wherein the adjustment lever has a fitting protrusion (416) formed at an end thereof and couples to a roller (418) having a fitting groove (417) formed so as to be fitted and coupled to the fitting protrusion (416).

6. The center bracket for adjusting the sprinkler body of claim 1, wherein a locking device (100) is formed on the center bracket (410), a locker protrusion (30) is mounted on an upper surface of the center bracket (410) and formed at one end portion of a locker body (10) that is rotated with a fixture (50) as the central axis of rotation, a spring protrusion (20) is formed at the other end portion, an elastic spring (60) is installed on the spring protrusion (20), a fixing hole (40) is formed at a central portion of the locker body (10), a fixing protrusion (490) is formed on one side of the center bracket (410), a fixing hole (492) is formed in the fixing protrusion (490), a locker protrusion through-hole (494) is formed on one side of the fixing protrusion (490) and the locker protrusion (30) of the locker body (10) is inserted, and a locker protrusion locking groove (480-1) is formed in a cam protrusion so that a handle (446) of a cam protrusion contact part does not rotate and the locker protrusion (30) is inserted into the locker protrusion locking groove (480-1) to form a locked state.

7. The center bracket for adjusting the sprinkler body of claim 1, wherein the sprinkler contact piece (420) is formed with auxiliary rotary protrusions (519 and 519′) protruding from an end of a rotating part, so that the auxiliary rotary protrusions (519 and 519′) are pushed and the sprinkler contact piece (420) is rotated to wind and rotate the sprinkler body when the sprinkler body (200) is fitted.
